(19) United States
(12) Patent Application Publication
(10) Pub. No.: US 2009/0291670 A1
(43) Pub. Date: Nov. 26, 2009

(54) DEVICE BEHAVIOR FOR CMAS ALERT TO IDLE MOBILE DEVICE

(75) Inventors: DeWayne Allan Sennett, Redmond, WA (US); Brian Kevin Daly, Seattle, WA (US)

Correspondence Address: AT&T Legal Department - WW, Patent Docketing Room 2A-207, One AT&T Way, Bedminster, NJ, 07921, US

(73) Assignee: AT&T MOBILITY II LLC, Atlanta, GA (US)

(21) Appl. No.: 12/262,272

(22) Filed: Oct. 31, 2008

Related U.S. Application Data
(60) Provisional application No. 61/055,361, filed on May 22, 2008.

(51) Int. Cl. H04M 3/42

(52) U.S. Cl. 455/412.2

(57) ABSTRACT

A mobile device is configured to process a Commercial Mobile Alert Message System (CMAS) alert message via various processing states. The various states allow the mobile device to implement user preferences, such as, for example, a preference to not be notified of a CMAS alert and to provide notification of an alert in a specified manner. Example states include an idle state, an analysis state, a storage state, a render state, a notification state, and a wait state.

### CROSS REFERENCE TO RELATED APPLICATIONS

The present application claims priority to U.S. Provisional Patent Application No. 61/055,361, entitled “DEVICE BEHAVIOR STATE DIAGRAM FOR CMAS ALERT TO IDLE MOBILE BEHAVIOR,” filed May 22, 2008, which is hereby incorporated by reference in its entirety.

### TECHNICAL FIELD

The technical field relates generally to cellular communications, and more specifically to the Commercial Mobile Alert System (CMAS). Even more specifically, the technical field relates to actions taken by a mobile device when receiving a CMAS message.

### BACKGROUND

Commercial Mobile Alert System (CMAS) alert messages can be provided to subscribers via mobile devices. The alert messages can be indicative of Presidential alert messages, Imminent Threat to Life and Property, and/or a Child Abduction Emergency (AMBER Alert). When a mobile device receives an indication of a CMAS alert, the mobile device should be configured to appropriately handle the alert.

### SUMMARY

The behavior of an idle mobile device when the mobile device receives an indication of a Commercial Mobile Alert Message System (CMAS) alert comprises various states in which the mobile device can reside, and from which the mobile device can perform various functions. The various states allow the mobile device to implement user preference. In an example embodiment, states include an idle state, an analysis state, a storage state, a render state, a notification state, and a wait state.

### BRIEF DESCRIPTION OF THE DRAWINGS

FIG. 1 is a state diagram depicting an example process and state transitions for receiving and handling a CMAS alert.

FIG. 2 is a diagram of an example process and system comprising a mobile device configured to receive and process a CMAS alert.

FIG. 3 is a block diagram of an example processor for processing a CMAS alert.

FIG. 4 depicts an overall block diagram of an exemplary packet-based mobile cellular network environment in which a CMAS alert can be processed.

FIG. 5 illustrates an architecture of a typical GPRS network in which a CMAS alert can be processed.

FIG. 6 illustrates another exemplary block diagram view of a GSM/GPRS/IP multimedia network architecture in which a CMAS alert can be processed.

### DETAILED DESCRIPTION OF ILLUSTRATIVE EMBODIMENTS

Commercial Mobile Alert System (CMAS) alert messages can be provided to subscribers via mobile devices. The alert messages can be indicative of Presidential alert messages, Imminent Threat to Life and Property, and/or a Child Abduction Emergency (AMBER Alert). A subscriber has the ability to “opt out” from having a category of CMAS message rendered on his/her mobile device. That is, the subscriber can program his/her mobile device to, for example, display only certain types of CMAS messages. Accordingly, when a CMAS message is received by a mobile device, the mobile device analyzes the CMAS message to determine if a subscriber has opted-out from having the message rendered on his/her device.

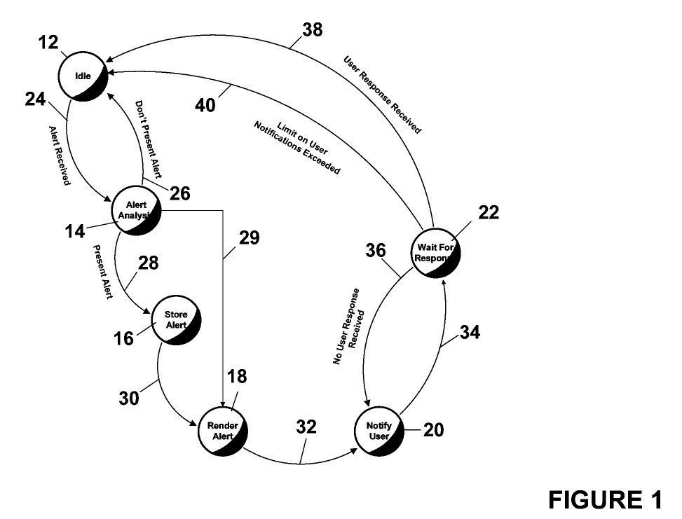

FIG. 1 is a state diagram depicting an example process for receiving and processing a CMAS alert. The various states and transitions therebetween of FIG. 1 are described with respect to the receipt and processing of a CMAS alert message. It is to be understood however, that application of the various states and transitions therebetween described herein are not limited to receiving and processing a CMAS alert message, but are also applicable to receiving and processing any indication of, or portion of a CMAS alert message.

As depicted in FIG. 1, a mobile device is in the Idle state 12 monitoring the appropriate broadcast channels for the arrival of a CMAS alert message, portion, or indication thereof. In an example embodiment, the receiver of the mobile device can be turned off to conserve power. When power is applied to the receiver, the mobile device enters the Idle state 12. When the mobile device receives a CMAS alert message, the mobile device enters an Alert Analysis state 14, via state transition process 24. State transition processes as described herein can comprise any appropriate process for transitioning between states, and is not limited to any specific process.

In the AlertAnalysis state 14, the mobile device analyzes the received CMAS alert message to determine if it should be rendered to the subscriber via the subscriber's mobile device. The mobile device makes this determination by comparing the parameters of the received CMAS alert message with the subscriber's CMAS opt-out configuration on the mobile device. The received CMAS alert message will be rendered via the mobile device if the CMAS alert message parameters meet the settings of the subscriber's CMAS opt-out configuration. Thus, the subscriber can program his/her mobile device to render all or a subset of received CMAS alert messages. In an example embodiment, a received Presidential CMAS alert message is always rendered on a subscriber's mobile device. If the received CMAS alert message is not to be rendered, the received CMAS alert message is discarded and the mobile device returns to the Idle state 12, via state transition process 26. If the received CMAS alert message is to be rendered, the mobile device enters the Store Alert state 16, via state transition process 28. In an example embodiment, if the received CMAS alert message is to be rendered, the mobile device goes directly from the Alert Analysis state 14 to the Render Alert state 18, via state transition process 29.

When the mobile device enters the Store Alert state 16, the mobile device stores the received CMAS alert message in the mobile device's internal memory for possible future retrieval. In an example embodiment, if there is not sufficient space in the mobile device's internal memory for the newly received CMAS alert message, the mobile device can replace the oldest expired CMAS alert message with the newly received CMAS alert message. If there is not sufficient space in the mobile device's internal memory for the newly received CMAS alert message and there are no expired CMAS alert messages in the mobile device's internal memory, the mobile device can replace the oldest non-expired CMAS alert message with the newly received CMAS alert message. In yet another example embodiment, if there is not sufficient space in the mobile device's internal memory for the newly received CMAS alert message, the mobile device can store the newly received message in a database external to the mobile device. After storing the received CMAS alert message, the mobile device enters the Render Alert state 18, via state transition process 30.

In the Render Alert state 18, the mobile device visually, mechanically, and/or audibly renders the received CMAS alert message via a display, speaker, mechanical vibrator, or the like of the mobile device. In an example embodiment, the text portion of the received CMAS alert message is visually rendered. In various example embodiments, the received CMAS alert message can be visually displayed via text, via an image or images, via video, via multimedia, or a combination thereof. In an example embodiment, the visual rendering of the received CMAS alert message will override any other information which is currently being presented on the visual display of the idle mobile device. Optionally, in addition, to the visual rendering of the received CMAS alert message, the mobile device can provide an indication of which button or soft key the subscriber should use to acknowledge the CMAS alert message to the mobile device. After the CMAS alert message is visually rendered and acknowledgement key instructions are presented on the visual display of the mobile device, the mobile enters the Notify User state 20, via state transition process 32.

In an example embodiment, when the mobile device enters the Notify User state 20, the mobile device will first retrieve subscriber's settings, such as settings for an audible CMAS alert tone and a CMAS vibration cadence. If the subscriber's setting for the audible CMAS alert tone is enabled (e.g., not in silent mode), the mobile device will initiate the audible CMAS alert tone. If the subscriber's setting for the CMAS vibration cadence is enabled, the mobile device will initiate the CMAS vibration cadence. Both the audible CMAS alert tone and the CMAS vibration cadence can be repeated multiple times before there is a pause in the user notification. The total duration of the audible CMAS alert tone and CMAS vibration sequences between pauses can be based upon predefined or provisioned settings on the mobile device. After the audible CMAS alert tone and CMAS vibration cadence sequences have been initiated according to the subscriber's settings, the mobile device enters the Wait for User Response state 22, via state transition process 34.

In the Wait For Response state 22, the mobile device is waiting for the subscriber to use the indicated button or soft key to acknowledge the CMAS alert message. When the indicated button or soft key is activated, the mobile device discontinues the audible CMAS alert tone and CMAS vibration cadence and the mobile device returns to the Idle state 12, via state transition process 38. If the user has not acknowledged the CMAS alert message by the completion of the total audible CMAS alert tone and CMAS vibration sequences initiated in the Notify User state 20, the mobile device discontinues the audible CMAS alert tone and CMAS vibration cadence sequences. During this pause in the audible CMAS alert tone and CMAS vibration cadence sequence, the mobile device continues to monitor for acknowledgement of the CMAS alert message. If the subscriber acknowledges the CMAS alert message during this pause in the audible CMAS alert tone and CMAS vibration cadence sequence, the mobile device returns to the Idle state 12, via state transition process 38. If the subscriber does not acknowledge the CMAS alert message during this pause in the audible CMAS alert tone and CMAS vibration cadence sequences, the mobile device returns to the Notify User state 20, via state transition process 36, to re-initiate the next sequence of audible CMAS alert tone and CMAS vibration cadence. The length of the pause interval can be based upon predefined or provisioned settings on the mobile device. In an example embodiment, in order to prevent excessive usage of the mobile device battery, a limit is placed on when the mobile device will return to the Notify User state 20. This limit can be based upon predefined or provisioned settings on the mobile device and can be based upon total number of repeated audible CMAS alert tone and CMAS vibration cadence sequences, upon the total time duration since the arrival of the CMAS alert message, or a combination thereof. When the limit is exceeded, the mobile device returns to the Idle state 12, via state transition process 40.

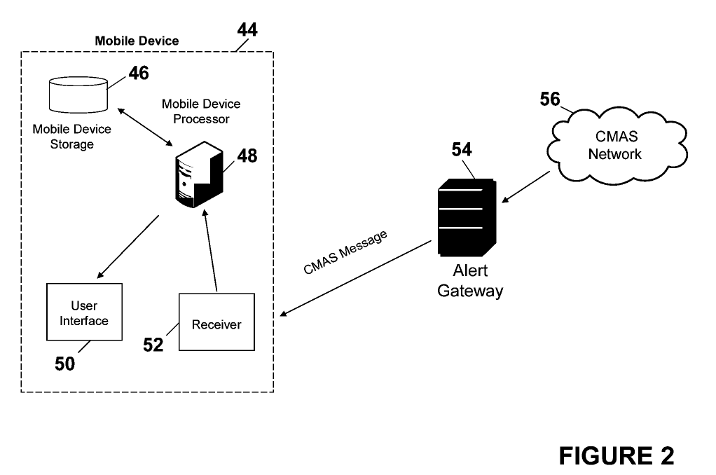

FIG. 2 is a diagram of an example process and system comprising a mobile device 44 configured to receive and process a CMAS alert message via the herein described CMAS message processing states. In an example embodiment, a CMAS message is provided from the CMAS network 56 to the mobile device 44 via an alert gateway 54. The source of the CMAS message can be the CMAS network 56, the alert gateway 54, or a combination thereof. The Alert gateway 54 can comprise any appropriate processor for providing and/or processing a CMAS alert message, an indication thereof, and/of a portion thereof. A number of CMAS messages can originate from the same source (e.g., an Alert Gateway 54 and/or the CMAS network 56) and/or be of the same type. In an example embodiment, when the mobile device 44 receives the CMAS message, the mobile device 44 is in the Idle state 12 as described above. The receiver 52 of the mobile device 44 receives the CMAS message and provides the CMAS message, and/or a portion thereof, to the mobile device processor 48. The mobile device processor 48 manages the transition between states and the functions performed in each state as described above. The CMAS message and notification are provided via a user interface 50 of the mobile device 44. Thus, the CMAS message and/or the notification of the CMAS message can be visually rendered, mechanically rendered, rendered via audio/acoustic means, or a combination thereof via the user interface.

In an example embodiment, when the mobile device 44 enters the Store Alert state 16, the mobile device 44 stores the received CMAS alert message in the mobile device's internal storage 46 for possible future retrieval. In an example embodiment, if there is not sufficient space in the mobile device's internal storage 46 for the newly received CMAS alert message, the mobile device 44 can replace the oldest expired CMAS alert message with the newly received CMAS alert message. If there is not sufficient space in the mobile device's internal storage 46 for the newly received CMAS alert message and there are no expired CMAS alert messages in the mobile device's internal storage 46, the mobile device 44 can replace the oldest non-expired CMAS alert message with the newly received CMAS alert message. In yet another example embodiment, if there is not sufficient space in the mobile device's internal storage 46 for the newly received CMAS alert message, the mobile device 44 can store the newly received message in a database external to the mobile device 44.

It is emphasized that the diagram depicted in FIG. 2 of the mobile device 44 is exemplary and not intended to imply a specific implementation. Thus, the mobile device 44 can be implemented in a single processor or multiple processors. Multiple processors can be distributed or centrally located. Multiple processors can communicate wirelessly, via hard wire, or a combination thereof. The mobile device 44 is representative of any appropriate type of mobile such as for example, a portable device, a variety of computing devices including a portable media player, e.g., a portable music player, such as an MP3 player, a Walkman, etc., a portable computing device, such as a laptop, a personal digital assistant (“PDA”), a portable phone, such as a cell phone or the like, a smart phone, a Session Initiation Protocol (SIP) phone, a video phone, a portable email device, a thin client, a portable gaming device, etc., consumer electronic devices, such as TVs, DVD players, set top boxes, monitors, displays, etc., a public computing device, such as a kiosk, a non-conventional computing device, such as a kitchen appliance, a motor vehicle control (e.g., steering wheel), etc., biometric sensors, radiological sensors, chemical sensors, biological sensors, or a combination thereof.

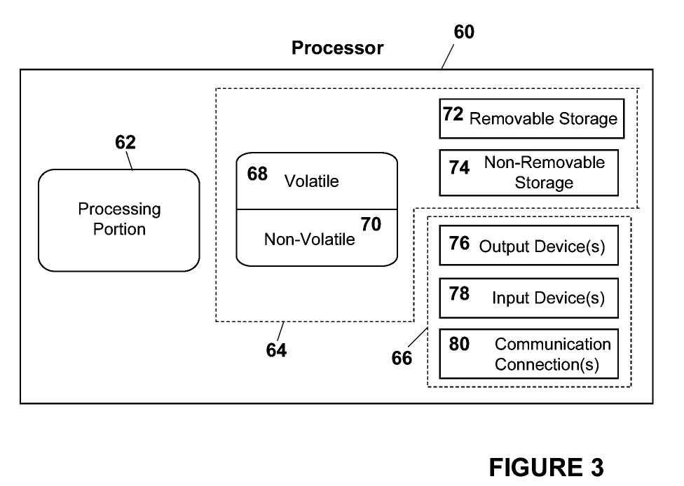

FIG. 3 is a block diagram of an example processor 60 for processing a CMAS alert via the herein described CMAS message processing states. In an example configuration, the processor 60 comprises various appropriate components of a cellular broadcast system wireless network, various components of the CMAS network, various components of the alert gateway, various components of the mobile device, or a combination thereof. It is emphasized that the block diagram depicted in FIG. 3 is exemplary and not intended to imply a specific implementation. Thus, the processor 60 can be implemented in a single processor or multiple processors. Multiple processors can be distributed or centrally located. Multiple processors can communicate wirelessly, via hard wire, or a combination thereof.

The processor 60 comprises a processing portion 62, a memory portion 64, and an input/output portion 66. The processing portion 62, memory portion 64, and input/output portion 66 are coupled together (coupling not shown in FIG. 3) to allow communications therebetween. The input/output portion 66 is capable of receiving CMAS messages. The processing portion 62 is capable of processing CMAS messages, managing the transition between states, and performing the functions performed in each state as described above.

The processor 60 can be implemented as a client processor and/or a server processor. In a basic configuration, the processor 60 can include at least one processing portion 62 and memory portion 64. The memory portion 64 can store any information utilized in conjunction with processing CMAS messages via the herein described states. For example, as described above, the memory portion 64 is capable of storing CMAS messages as described above. Depending upon the exact configuration and type of processor, the memory portion 64 can be volatile 68 (such as RAM), non-volatile 70 (such as ROM, flash memory, etc.), or a combination thereof. The processor 60 can have additional features/functionality. For example, the processor 60 can include additional storage (removable storage 72 and/or non-removable storage 74) including, but not limited to, magnetic or optical disks, tape, flash, smart cards or a combination thereof. Computer storage media can include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor. Any such computer storage media can be part of the processor.

The processor 60 also can contain communications connection(s) that allow the processor 60 to communicate with other devices, for example. A communications connection(s) can comprise communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor also can have input device(s) 78 such as keyboard, mouse, pen, voice input device, touch input device, etc. Output device(s) 76 such as a display, speakers, printer, etc. also can be included.

The following description sets forth some exemplary telephony radio networks and non-limiting operating environments in which a mobile device managing the states of CMAS message processing can be implemented. The below-described operating environments should be considered non-exhaustive, however, and thus the below-described network architectures merely show how a mobile device managing the states of CMAS message processing can be incorporated into existing network structures and architectures. It can be appreciated, however, that a mobile device managing the states of CMAS message processing can be incorporated into existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (“GPRS”), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

As one of ordinary skill in the art can appreciate, the exemplary GSM/GPRS environment and services described herein also can be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), 4G Services such as Long Term Evolution (LTE), etc., as well as to other network services that become available in time. In this regard, the techniques of the utilization of SMS and/or cellular broadcast to receive multimedia alerts can be applied independently of the method of data transport, and do not depend on any particular network architecture, or underlying protocols.

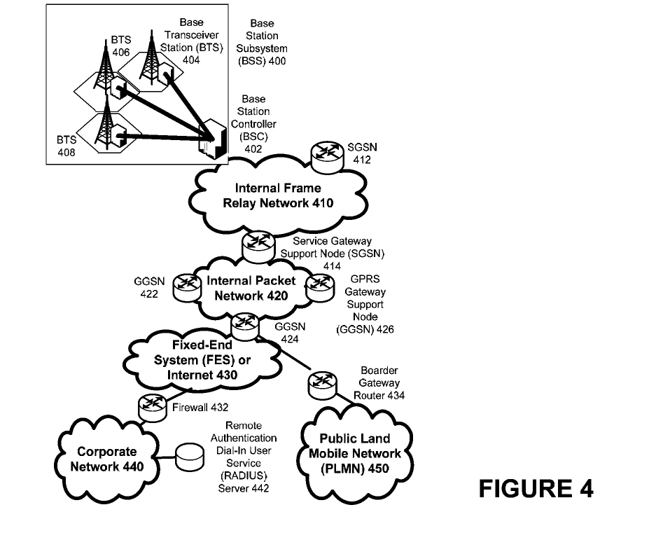

FIG. 4 depicts an overall block diagram of an exemplary packet-based mobile cellular network environment, such as a GPRS network, in which a CMAS alert message can be processed. In an example configuration, the CMAS network 56 is encompassed by the network environment depicted in FIG. 4. In such an environment, there are a plurality of Base Station Subsystems (“BSS”) 400 (only one is shown), each of which comprises a Base Station Controller (“BSC”) 402 serving a plurality of Base Transceiver Stations (“BTS”) such as BTSs 404, 406, and 408. BTSs 404, 406, 408, etc. are the access points where users of packet-based mobile devices become connected to the wireless network. In exemplary fashion, the packet traffic originating from user devices (e.g., mobile devices) is transported via an over-the-air interface to a BTS 408, and from the BTS 408 to the BSC 402. Base station subsystems, such as BSS 400, are a part of internal frame relay network 410 that can include Service GPRS Support Nodes (“SGSN”) such as SGSN 412 and 414. Each SGSN is connected to an internal packet network 420 through which a SGSN 412, 414, etc. can route data packets to and from a plurality of gateway GPRS support nodes (GGSN) 422, 424, 426, etc. As illustrated, SGSN 414 and GGSNs 422, 424, and 426 are part of internal packet network 420. Gateway GPRS serving nodes 422, 424 and 426 mainly provide an interface to external Internet Protocol (“IP”) networks such as Public Land Mobile Network (“PLMN”) 450, corporate intranets 440, or Fixed-End System (“FES”) or the public Internet 430. As illustrated, subscriber corporate network 440 may be connected to GGSN 424 via firewall 432; and PLMN 450 is connected to GGSN 424 via boarder gateway router 434. The Remote Authentication Dial-In User Service (“RADIUS”) server 442 may be used for caller authentication when a user of a mobile cellular device calls corporate network 440.

Generally, there can be four different cell sizes in a GSM network, referred to as macro, micro, pico, and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. On the other hand, umbrella cells are used to cover shadowed regions of smaller cells and fill in gaps in coverage between those cells.

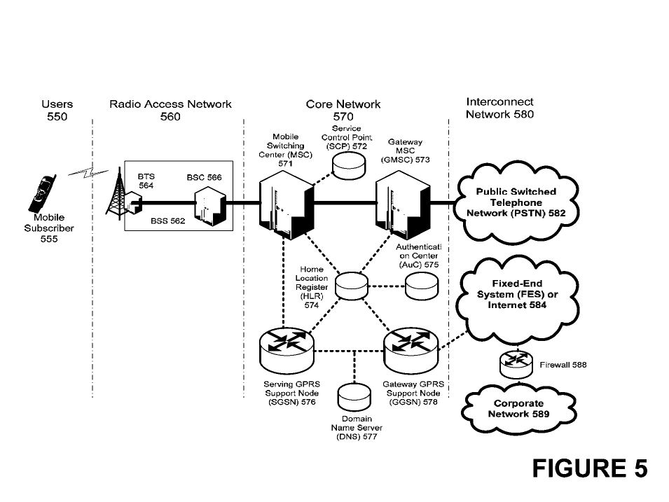

FIG. 5 illustrates an architecture of a typical GPRS network in which a CMAS alert can be processed. The architecture depicted in FIG. 5 is segmented into four groups: users 550, radio access network 560, core network 570, and interconnect network 580. Users 550 comprise a plurality of end users (though only mobile subscriber 555 is shown in FIG. 5). In an example embodiment, the device depicted as mobile subscriber 555 comprises a mobile device. Radio access network 560 comprises a plurality of base station subsystems such as BSSs 562, which include BTSs 564 and BSCs 566. Core network 570 comprises a host of various network elements. As illustrated here, core network 570 may comprise Mobile Switching Center (“MSC”) 571, Service Control Point (“SCP”) 572, gateway MSC 573, SGSN 576, Home Location Register (“HLR”) 574, Authentication Center (“AuC”) 575, Domain Name Server (“DNS”) 577, and GGSN 578. Interconnect network 580 also comprises a host of various networks and other network elements. As illustrated in FIG. 5, interconnect network 580 comprises Public Switched Telephone Network (“PSTN”) 582, Fixed-End System (“FES”) or Internet 584, firewall 588, and Corporate Network 589.

A mobile switching center can be connected to a large number of base station controllers. At MSC 571, for instance, depending on the type of traffic, the traffic may be separated in that voice may be sent to Public Switched Telephone Network (“PSTN”) 582 through Gateway MSC (“GMSC”) 573, and/or data may be sent to SGSN 576, which then sends the data traffic to GGSN 578 for further forwarding.

When MSC 571 receives call traffic, for example, from BSC 566, it sends a query to a database hosted by SCP 572. The SCP 572 processes the request and issues a response to MSC 571 so that it may continue call processing as appropriate.

The HLR 574 is a centralized database for users to register to the GPRS network. HLR 574 stores static information about the subscribers such as the International Mobile Subscriber Identity (“IMSI”), subscribed services, and a key for authenticating the subscriber. HLR 574 also stores dynamic subscriber information such as the current location of the mobile subscriber. Associated with HLR 574 is AuC 575. AuC 575 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 5, when mobile subscriber 555 initiates the attach process by turning on the network capabilities of the mobile device, an attach request is sent by mobile subscriber 555 to SGSN 576. The SGSN 576 queries another SGSN, to which mobile subscriber 555 was attached before, for the identity of mobile subscriber 555. Upon receiving the identity of mobile subscriber 555 from the other SGSN, SGSN 576 requests more information from mobile subscriber 555. This information is used to authenticate mobile subscriber 555 to SGSN 576 by HLR 574. Once verified, SGSN 576 sends a location update to HLR 574 indicating the change of location to a new SGSN, in this case SGSN 576. HLR 574 notifies the old SGSN, to which mobile subscriber 555 was attached before, to cancel the location process for mobile subscriber 555. HLR 574 then notifies SGSN 576 that the location update has been performed. At this time, SGSN 576 sends an Attach Accept message to mobile subscriber 555, which in turn sends an Attach Complete message to SGSN 576.

After attaching itself with the network, mobile subscriber 555 then goes through the authentication process. In the authentication process, SGSN 576 sends the authentication information to HLR 574, which sends information back to SGSN 576 based on the user profile that was part of the user's initial setup. The SGSN 576 then sends a request for authentication and ciphering to mobile subscriber 555. The mobile subscriber 555 uses an algorithm to send the user identification (ID) and password to SGSN 576. The SGSN 576 uses the same algorithm and compares the result. If a match occurs, SGSN 576 authenticates mobile subscriber 555.

Next, the mobile subscriber 555 establishes a user session with the destination network, corporate network 589, by going through a Packet Data Protocol (“PDP”) activation process. Briefly, in the process, mobile subscriber 555 requests access to the Access Point Name (“APN”), for example, UPS.com, and SGSN 576 receives the activation request from mobile subscriber 555. SGSN 576 then initiates a Domain Name Service (“DNS”) query to learn which GGSN node has access to the UPS.com APN. The DNS query is sent to the DNS server within the core network 570, such as DNS 577, which is provisioned to map to one or more GGSN nodes in the core network 570. Based on the APN, the mapped GGSN 578 can access the requested corporate network 589. The SGSN 576 then sends to GGSN 578 a Create Packet Data Protocol (“PDP”) Context Request message that contains necessary information. The GGSN 578 sends a Create PDP Context Response message to SGSN 576, which then sends an Activate PDP Context Accept message to mobile subscriber 555.

Once activated, data packets of the call made by mobile subscriber 555 can then go through radio access network 560, core network 570, and interconnect network 580, in a particular fixed-end system or Internet 584 and firewall 588, to reach corporate network 589.

Thus, network elements that can invoke the functionality of CMAS message identifiers can include but are not limited to Gateway GPRS Support Node tables, Fixed End System router tables, firewall systems, VPN tunnels, and any number of other network elements as required by the particular digital network.

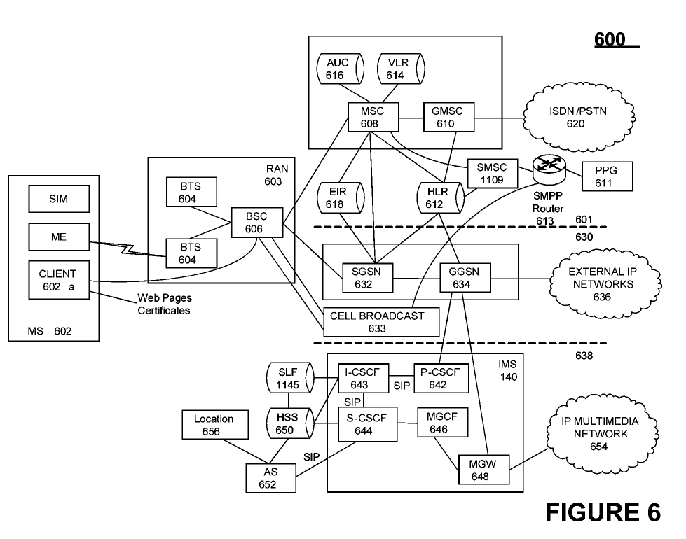

FIG. 6 illustrates another exemplary block diagram view of a GSM/GPRS/IP multimedia network architecture 600 with which a mobile device managing the states of CMAS message processing can be utilized. As illustrated, architecture 600 of FIG. 6 includes a GSM core network 601, a GPRS network 630 and an IP multimedia network 638. The GSM core network 601 includes a Mobile Station (MS) 602, at least one Base Transceiver Station (BTS) 604 and a Base Station Controller (BSC) 606. The MS 602 is physical equipment or Mobile Equipment (ME), such as a mobile phone or a laptop computer (e.g., user device 22) that is used by mobile subscribers, with a Subscriber identity Module (SIM). The SIM includes an International Mobile Subscriber Identity (IMSI), which is a unique identifier of a subscriber. The BTS 604 is physical equipment, such as a radio tower, that enables a radio interface to communicate with the MS. Each BTS may serve more than one MS. The BSC 606 manages radio resources, including the BTS. The BSC may be connected to several BTSs. The BSC and BTS components, in combination, are generally referred to as a base station (BSS) or radio access network (RAN) 603.

The GSM core network 601 also includes a Mobile Switching Center (MSC) 608, a Gateway Mobile Switching Center (GMSC) 610, a Home Location Register (HLR) 612, Visitor Location Register (VLR) 614, an Authentication Center (AuC) 618, and an Equipment Identity Register (EIR) 616. The MSC 608 performs a switching function for the network. The MSC also performs other functions, such as registration, authentication, location updating, handovers, and call routing. The GMSC 610 provides a gateway between the GSM network and other networks, such as an Integrated Services Digital Network (ISDN) or Public Switched Telephone Networks (PSTNs) 620. Thus, the GMSC 610 provides interworking functionality with external networks.

The HLR 612 is a database that contains administrative information regarding each subscriber registered in a corresponding GSM network. The HLR 612 also contains the current location of each MS. The VLR 614 is a database that contains selected administrative information from the HLR 612. The VLR contains information necessary for call control and provision of subscribed services for each MS currently located in a geographical area controlled by the VLR. The HLR 612 and the VLR 614, together with the MSC 608, provide the call routing and roaming capabilities of GSM. The AuC 616 provides the parameters needed for authentication and encryption functions. Such parameters allow verification of a subscriber's identity. The EIR 618 stores security-sensitive information about the mobile equipment.

A Short Message Service Center (SMSC) 609 allows one-to-one Short Message Service (SMS) messages to be sent to/from the MS 602. A Push Proxy Gateway (PPG) 611 is used to “push” (i.e., send without a synchronous request) content to the MS 602. The PPG 611 acts as a proxy between wired and wireless networks to facilitate pushing of data to the MS 602. A Short Message Peer to Peer (SMPP) protocol router 613 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 602 sends a location update including its current location information to the MSC/VLR, via the BTS 604 and the BSC 606. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 630 is logically implemented on the GSM core network architecture by introducing two packet-switching network nodes, a serving GPRS support node (SGSN) 632, a cell broadcast and a Gateway GPRS support node (GGSN) 634. The SGSN 632 is at the same hierarchical level as the MSC 608 in the GSM network. The SGSN controls the connection between the GPRS network and the MS 602. The SGSN also keeps track of individual MS's locations and security functions and access controls.

A Cell Broadcast Center (CBC) 633 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 634 provides a gateway between the GPRS network and a public packet network (PDN) or other IP networks 636. That is, the GGSN provides interworking functionality with external networks, and sets up a logical link to the MS through the SGSN. When packet-switched data leaves the GPRS network, it is transferred to an external TCP-IP network 636, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 630 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel. In a NOM3 network, a MS can monitor pages for a circuit switched network while received data and vise versa.

The IP multimedia network 638 was introduced with 3GPP Release 5, and includes an IP multimedia subsystem (IMS) 640 to provide rich multimedia services to end users. A representative set of the network entities within the IMS 640 are a call/session control function (CSCF), a media gateway control function (MGCF) 646, a media gateway (MGW) 648, and a master subscriber database, called a home subscriber server (HSS) 650. The HSS 650 may be common to the GSM network 601, the GPRS network 630 as well as the IP multimedia network 638.

The IP multimedia system 640 is built around the call/session control function, of which there are three types: an interrogating CSCF (I-CSCF) 643, a proxy CSCF (P-CSCF) 642, and a serving CSCF (S-CSCF) 644. The P-CSCF 642 is the MS's first point of contact with the IMS 640. The P-CSCF 642 forwards session initiation protocol (SIP) messages received from the MS to an SIP server in a home network (and vice versa) of the MS. The P-CSCF 642 may also modify an outgoing request according to a set of rules defined by the network operator (for example, address analysis and potential modification).

The I-CSCF 643, forms an entrance to a home network and hides the inner topology of the home network from other networks and provides flexibility for selecting an S-CSCF. The I-CSCF 643 may contact a subscriber location function (SLF) 645 to determine which HSS 650 to use for the particular subscriber, if multiple HSS's 650 are present. The S-CSCF 644 performs the session control services for the MS 602. This includes routing originating sessions to external networks and routing terminating sessions to visited networks. The S-CSCF 644 also decides whether an application server (AS) 652 is required to receive information on an incoming SIP session request to ensure appropriate service handling. This decision is based on information received from the HSS 650 (or other sources, such as an application server 652). The AS 652 also communicates to a location server 656 (e.g., a Gateway Mobile Location Center (GMLC)) that provides a position (e.g., latitude/longitude coordinates) of the MS 602.

The HSS 650 contains a subscriber profile and keeps track of which core network node is currently handling the subscriber. It also supports subscriber authentication and authorization functions (AAA). In networks with more than one HSS 650, a subscriber location function provides information on the HSS 650 that contains the profile of a given subscriber.

The MGCF 646 provides interworking functionality between SIP session control signaling from the IMS 640 and ISUP/BICC call control signaling from the external GSTN networks (not shown). It also controls the media gateway (MGW) 648 that provides user-plane interworking functionality (e.g., converting between AMR- and PCM-coded voice). The MGW 648 also communicates with other IP multimedia networks 654.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While example embodiments of a mobile device managing the states of CMAS message processing have been described in connection with various computing devices/processor, the underlying concepts can be applied to any computing device, processor, or system capable of utilizing CMAS messages. The various techniques described herein can be implemented in connection with hardware or software or, where appropriate, with a combination of both. Thus, the methods and apparatuses for managing CMAS message processing states, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for managing CMAS message processing states. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for managing CMAS message processing states also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for the utilization of CMAS message processing states. When implemented on a general-purpose processor, the program code combines with the processor to provide a unique apparatus that operates to invoke the functionality of CMAS message processing states. Additionally, any storage techniques used in connection with the utilization of CMAS message processing states can invariably be a combination of hardware and software.

While CMAS message processing states have been described in connection with the various embodiments of the various figures, it is to be understood that other similar embodiments can be used or modifications and additions can be made to the described embodiment for performing the same function of utilizing CMAS message processing states without deviating therefrom. For example, one skilled in the art will recognize that the utilization of CMAS message processing states as described herein may apply to any environment, whether wired or wireless, and may be applied to any number of such devices connected via a communications network and interacting across the network. Therefore, CMAS message processing states should not be limited to any single embodiment, but rather should be construed in breadth and scope in accordance with the appended claims.

What is claimed:

1. A method for processing a Commercial Mobile Alert Message System (CMAS) message, the method comprising:
in an idle state, receiving a CMAS message;
from the idle state, entering an alert analysis state;
in the alert analysis state, determining if the received CMAS message is to be rendered;
if it is determined that the received CMAS is not to be rendered, returning to the idle state;
if it is determined that the received CMAS is to be rendered, entering a render state;
in the render state, rendering the received CMAS message;
from the render state, entering a notify state;
in the notify state, providing a notification of the received CMAS message;
from the notify state, entering a wait state;
in the wait state, if acknowledgment is not received, returning to the notify state; and
in the wait state, if acknowledgment is received, returning to the idle state.

2. The method in accordance with claim 1, further comprising:
in the alert analysis state, if it is determined that the received CMAS is to be rendered, storing the received CMAS message before entering the render state.

3. The method in accordance with claim 1, wherein:
a number of times a transition occurs between the wait state and the notify state is predetermined; and
when the predetermined number of times is reached, the idle state is reentered.

4. The method in accordance with claim 1, wherein the received CMAS message is at least one of visually rendered, mechanically rendered, or audibly rendered.

5. The method in accordance with claim 1, wherein the notification is provided at least one of visually, mechanically, or audibly.

6. A mobile device configured to process a Commercial Mobile Alert Message System (CMAS) message, the mobile device configured to:
in an idle state, receive a CMAS message;
from the idle state, enter an alert analysis state;
in the alert analysis state, determine if the received CMAS message is to be rendered;
if it is determined that the received CMAS is not to be rendered, return to the idle state;
if it is determined that the received CMAS is to be rendered, enter a render state;
in the render state, render the received CMAS message;
from the render state, enter a notify state;
in the notify state, provide a notification of the received CMAS message;
from the notify state, enter a wait state;
in the wait state, if acknowledgment is not received, return to the notify state; and
in the wait state, if acknowledgment is received, return to the idle state.

7. The mobile device in accordance with claim 6, further configured to:
in the alert analysis state, if it is determined that the received CMAS is to be rendered, store the received CMAS message before entering the render state.

8. The mobile device in accordance with claim 6, wherein:
a number of times a transition occurs between the wait for acknowledgement state and the notify state is predetermined; and
when the predetermined number of times is reached, the idle state is reentered.

9. The mobile device in accordance with claim 6, wherein the received CMAS message is at least one of visually rendered, mechanically rendered, or audibly rendered.

10. The mobile device in accordance with claim 6, wherein the notification if provided at least one of visually, mechanically, or audibly.
